(19) United States
(12) Patent Application Publication
(10) Pub. No.: US 2010/0013622 A1
(43) Pub. Date: Jan. 21, 2010

(54) Adaptive light seatbelt buckle

(75) Inventors: Dennis Scott Rumps, Howell, MI (US); Leonard Steven Cech, Brighton, MI (US)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 12/219,321

(22) Filed: Jul. 18, 2008

(51) Int. Cl. B60Q 1/00

(52) U.S. Cl. 340/457.1

(57) ABSTRACT

An adaptive light seatbelt system is provided. The system includes a buckle housing, a light positioned in the buckle housing so that the light is visible to an occupant of a vehicle, a controller for controlling the light, and a signaler for providing an input to the controller. The system indicates a state of the buckle housing by controlling the light.

### BACKGROUND

The present disclosure relates generally to the field of automobile safety equipment. More specifically, the present disclosure relates to the use of light devices in conjunction with automobile seatbelt systems.

Conventional seatbelt systems do not incorporate a controllable lighting element capable of indicating the current state of the seatbelt buckle. The state of the seatbelt buckle can convey useful information to passengers of a vehicle as well as rescue personnel.

In light of the above, there is a need for an improved seatbelt buckle.

### SUMMARY

According to one disclosed embodiment, an adaptive light seatbelt system for a vehicle includes a buckle housing, a light positioned in the buckle housing so that the light is visible to an occupant of a vehicle, a controller for controlling light, wherein the controller is located in the buckle housing, and a signaler for providing an input to the controller, wherein the signaler is located in the buckle housing.

According to another disclosed embodiment, a method of adaptively lighting a seatbelt buckle having a buckle housing is provided. The seatbelt buckle includes a light positioned in the buckle housing, a controller located in the buckle housing and connected to the light, and a signaler located in the buckle housing and connected to the controller. The method comprises the steps of receiving an input from the signaler at the controller, and controlling the light with the controller according to the input received from the signaler.

According to yet another disclosed embodiment, an adaptive light seatbelt system includes a buckle housing, a tongue, configured to insert into the buckle housing, a release mechanism, located in the buckle housing, for releasing the tongue, a light positioned in the buckle housing so that the light is visible to an occupant of a vehicle, a light diffuser located between an outer edge of the buckle housing and the light, a controller, located in the buckle housing for controlling the light and a signaler for providing an input to the controller, wherein the signaler is located in the buckle housing.

In a further disclosed embodiment, a method of adaptively lighting a seatbelt buckle is provided. The method comprises the steps of determining whether a tongue is inserted into a buckle housing, receiving an input, and controlling a light according to the input.

It is to be understood that both the foregoing general description and the following detailed description are exemplary and explanatory only, and are not restrictive of the invention as claimed. These and other features, aspects and advantages of the present invention will become apparent from the following description, appended claims, and the accompanying exemplary embodiments shown in the drawings, which are briefly described below.

### BRIEF DESCRIPTION

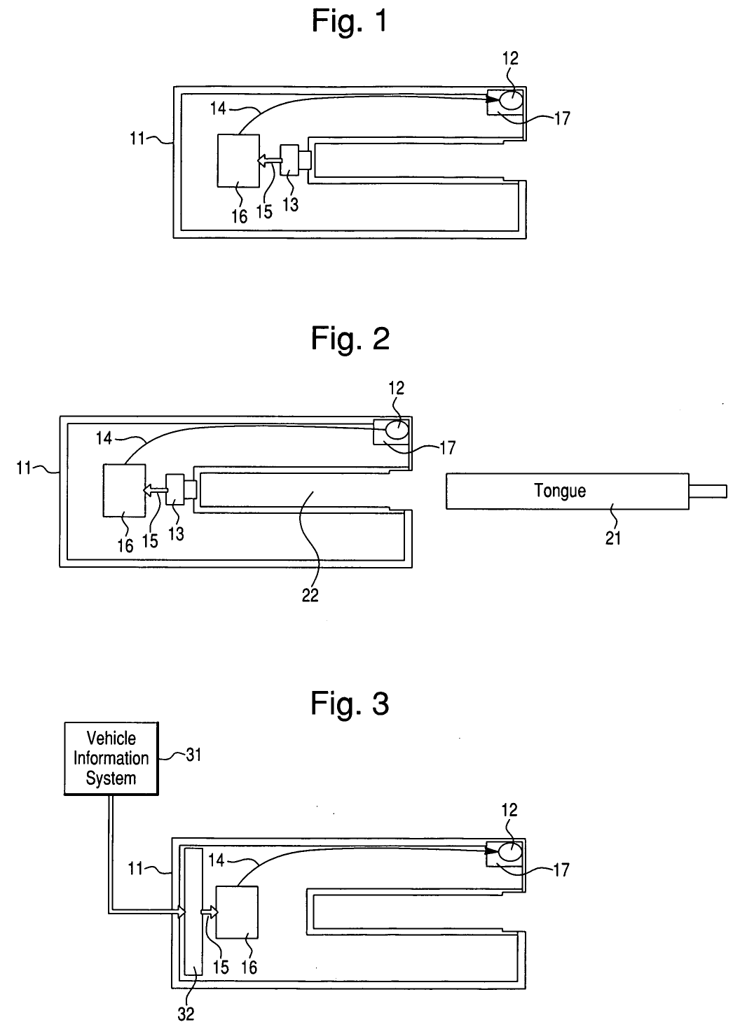

FIG. 1 is a sectional view of a buckle housing for an adaptive light seatbelt, according to one embodiment.

FIG. 2 is a sectional view of a buckle housing and a tongue for an adaptive light seatbelt, according to one embodiment.

FIG. 3 is a sectional view of a buckle housing for an adaptive light seatbelt, including a simplex communication system, according to one embodiment.

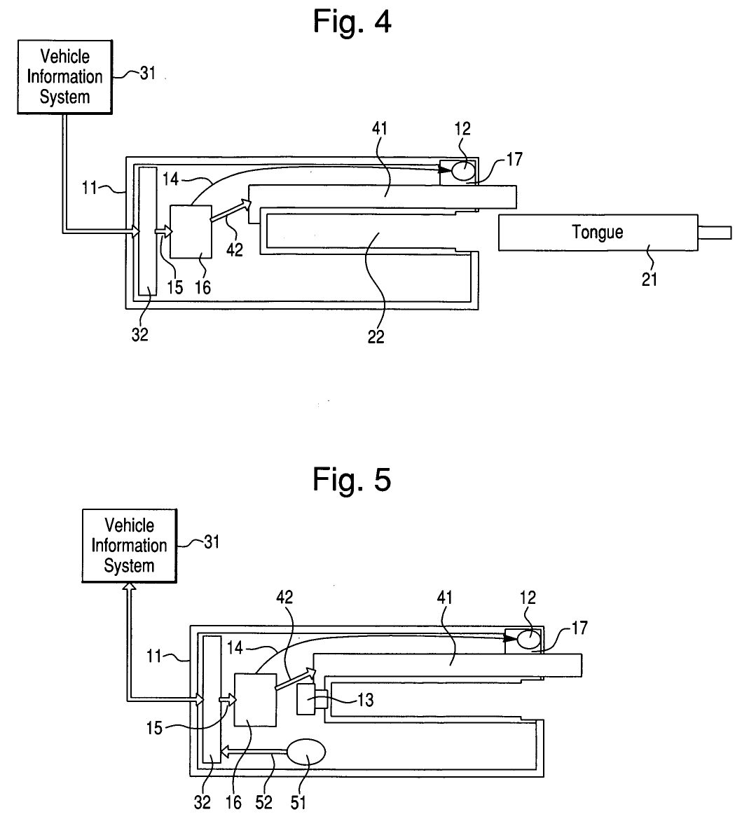

FIG. 4 is a sectional view of a buckle housing and a tongue for an adaptive light seatbelt, including a simplex communication system and a release mechanism, according to one embodiment.

FIG. 5 is a sectional view of a buckle housing for an adaptive light seatbelt, including a duplex communication system, a release mechanism, and a status sensor, according to one embodiment.

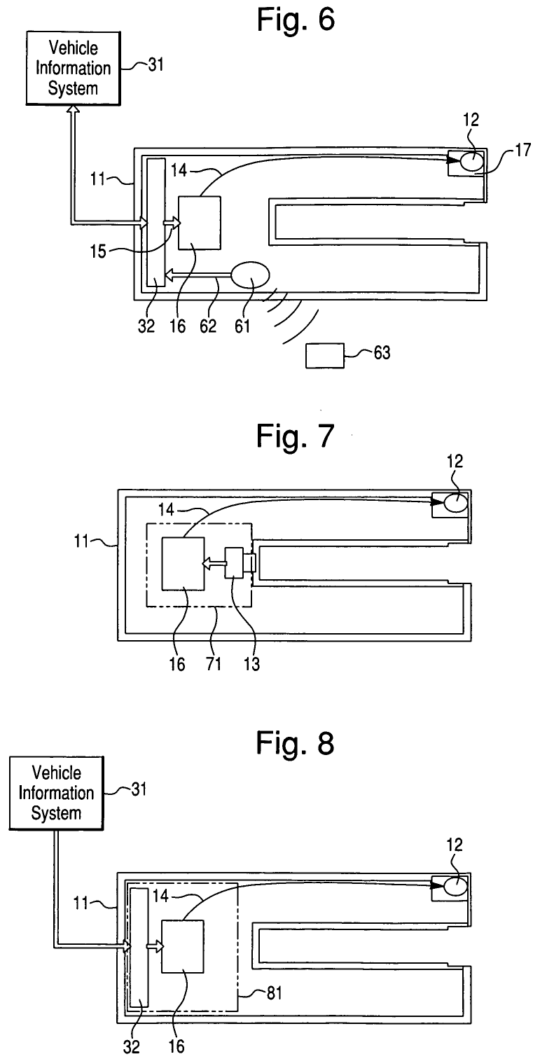

FIG. 6 is a sectional view of a buckle housing for an adaptive light seatbelt, including a duplex communication system and a radio frequency chip reader, according to one embodiment.

FIG. 7 is a sectional view of a buckle housing for an adaptive light seatbelt, including a switch and a controller housed in a system control unit, according to one embodiment.

FIG. 8 is a sectional view of a buckle housing for an adaptive light seatbelt, including a simplex communication system and a controller housed in a system control unit, according to one embodiment.

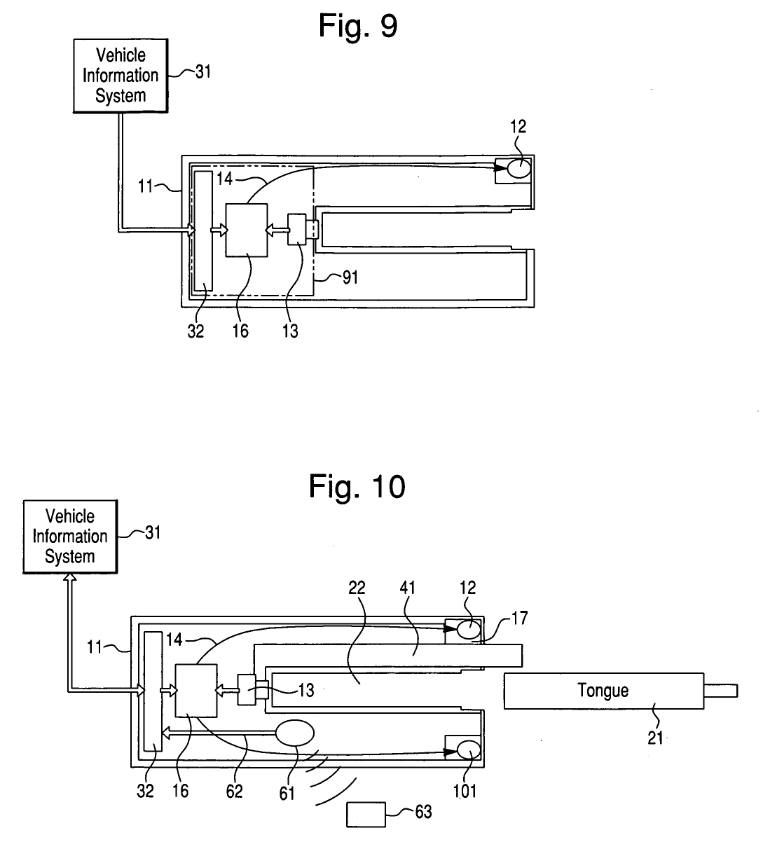

FIG. 9 is a sectional view of a buckle housing for an adaptive light seatbelt, including a simplex communication system, a switch, and a controller housed in a system control unit, according to one embodiment.

FIG. 10 is a sectional view of an adaptive light seatbelt, including a switch, a duplex communication system, a release mechanism, a second light, a radio frequency chip reader, and a tongue, according to one embodiment.

### DETAILED DESCRIPTION

Embodiments of the present invention will be described below with reference to the accompanying drawings. It should be understood that the following description is intended to describe exemplary embodiments of the invention, and not to limit the invention.

FIG. 1 is a sectional view of a buckle housing 11 for an adaptive light seatbelt, according to one embodiment. The illustrated embodiment includes a buckle housing 11, and a light 12 positioned in the buckle housing 11 so that the light is visible. The system includes a signaler 13, located in the buckle housing 11, and connected to a controller 16 by a connection 15. The signaler 13 provides an input through the connection 15 to the controller 16. The controller 16 is located in the buckle housing 11, and is connected to the light 12 by a connection 14. The controller 16 controls the light 12.

In one embodiment related to FIG. 1, the light 12 is an LED. In some embodiments, the LED is a conventional semiconductor diode LED. In other embodiments, the LED is a quantum dot LED composed of semiconductor nanocrystals. In yet other embodiments, the LED is an organic LED.

In some embodiments, the controller 16 is a computer board with a plurality of computer chips, designed to implement the desired control. In other embodiments, the controller 16 is part of a larger computer board, designed to implement a plurality of functions. Similarly, the signaler 13 may be a simple on-off switch connected to the controller 16. In alternative embodiments, the signaler 13 may be a computer board with a plurality of computer chips, designed to implement the desired signaling. In yet other embodiments, the signaler 13 may be part of a larger computer board, designed to implement a plurality of functions.

In some embodiments, the controller 16 controls at least one of a duty cycle, a brightness, and a color of the light 12. In such an embodiment, the controller 16 may control the brightness and the duty cycle of the light 12 to create a flashing effect. Additionally, the controller 16 may control the brightness, duty cycle and the color of the light 12 to create a colored flashing effect. For instance, in some embodiments, the controller 16 may control the light 12 to flash the color red or green. Alternatively, the controller 16 may control the light 12 to simply illuminate a color. In some embodiments, the controller 16 may also control the directionality of the light 12. In such an embodiment, the light emitted from the light 12 may be directed to occupy a particular region of space. In addition, the system may include a light diffuser 17. The light diffuser 17 is located between an outer edge of the buckle housing 11 and the light 12. The light diffuser 17 spreads or diffuses the light emitted from the light 12.

FIG. 2 is a sectional view of a buckle housing 11 and a tongue 21 for an adaptive light seatbelt, according to another embodiment of the present disclosure. The embodiment illustrated in FIG. 2 includes all the features as discussed and illustrated in FIG. 1. Additionally, the illustrated embodiment of FIG. 2 includes a tongue 21, configured to insert into a region of the buckle housing 22. In this embodiment, the signaler 13 is a switch. The switch 13 is configured to change states when the tongue 21 is inserted to the buckle housing 11.

In some embodiments, the controller 16 may control the color of the light 12 based on the state of switch 13. For instance, the controller 16 may control the light 12 to illuminate red when the state of the switch 13 indicates that the tongue 21 is not inserted into the buckle housing 11. The controller 16 may also control the light 12 to illuminate green when the state of the switch 13 indicates that the tongue 21 is inserted into the buckle housing 11.

FIG. 3 is a sectional view of a buckle housing 11 for an adaptive light seatbelt, including a simplex communication system 32, according to one embodiment. The embodiment illustrated in FIG. 3 includes all the features as discussed and illustrated in FIG. 1. However, in the embodiment of FIG. 3, the signaler 32 is a communication system. The communication system 32 is configured to communicate with a vehicle information system 31. In some embodiments, the communication system 32 is simplex and only receives communications from the vehicle information system 31. In other embodiments, the communication system 32 is duplex, and receives communications from the vehicle information system 31, as well as transmits communications to the vehicle information system 31.

In the illustrated embodiment of FIG. 3, the communication system 32 is a simplex communication system. The controller 16 controls the light 12 under a variety of different input signals received from the simplex communication system 32 following reception of a communication from the vehicle information system 31. For example, the vehicle information system 31 may send a communication to the simplex communication system 32 indicating that lighting outside a vehicle is low. Following reception of the communication, the simplex communication system 32 may provide an input to the controller 16 which increases the brightness of the light 12. In another example, the controller 16 may increase the brightness of the light 12 when a vehicle door is opened, to aid a passenger in properly inserting the tongue 21 into the buckle housing 11. Additionally, the vehicle information system 31 may be configured to send a communication to the simplex communication system 32 to cause the controller 16 to adjust at least one of the brightness, duty cycle, or color of the light 12 based on passenger input or pre-programmed lighting effects.

In another embodiment, the controller 16 may be configured to adjust at least one of the duty cycle, brightness, and color of the light 12 following a communication to the simplex communication system 32 indicating the vehicle has been involved in an accident. For example, the vehicle information system 31 may send a communication indicating the intensity of a vehicle accident to the simplex communication system 32, and the controller 16 may control the duty cycle, brightness, and color of the light 12 to create a flash in relation to the intensity of the accident. The flashing of the light 12 conveys important information to rescue personnel. Additionally, the controller 16 may be configured to adjust the duty cycle, brightness, and color of the light 12 to create a flash indicating that certain occupants of a vehicle were are securely fastened into their seatbelts at the time of the accident. Conversely, the controller 16 may be configured to adjust the duty cycle, brightness, and color of the light 12 to create a a flash indicating that certain occupants of a vehicle were not securely fastened into their seatbelts at the time of the accident.

The simplex communication system 32 may also directly control features of the system. By way of example, FIG. 4 is a sectional view of a buckle housing 11 and a tongue 21 for an adaptive light seatbelt, including a simplex communication system 32 and a release mechanism 41. In such an embodiment, the simplex communication system 32 is configured provide an input through connection 42 to the release mechanism 41 to release the tongue 21 from the buckle housing 11 on a communication from the vehicle information system 31. For example, the vehicle information system 31 may send a communication to release the tongue 21 to the simplex communication system 32 following a vehicle accident, allowing the occupants of a vehicle to more easily exit the vehicle.

FIG. 5 is a sectional view of a buckle housing 11 for an adaptive light seatbelt, including a duplex communication system 32, a release mechanism 41, and a status sensor 51 according to one embodiment. The illustrated embodiment includes all of the features discussed and illustrated in FIGS. 3 and 4. However, in the illustrated embodiment of FIG. 5, the communication system 32 is a duplex communication system configured to receive communications from the vehicle information system 31 as well as send communications to the vehicle information system 31. By way of example, FIG. 5 includes a status sensor 51 connected to the duplex communication system 32 through a connection 52. The status sensor 51 is configured to send status messages to the vehicle information system 31 by way of the duplex communication system 32 through the connection 52. The status sensor 51 may be configured to send a temperature of the buckle housing 11. The status sensor 51 may also be configured to send a status indicating whether the tongue 21 is inserted into the buckle housing 11 by an input received from the switch 13 indicating the state of the switch 13. Additionally, the status sensor 51 may be configured to send a status indicating whether a release mechanism 41 is degraded or non-functional.

FIG. 6 is a sectional view of a buckle housing 11 for an adaptive light seatbelt, including a duplex communication system 32 and a radio frequency chip reader 61, according to one embodiment. In such an embodiment, the radio chip reader 61 is connected to the duplex communication system 32 through a connection 62. The radio chip reader 61 is configured to read a radio frequency identification chip 63 which uniquely identifies an occupant. The unique identification of the occupant determined from the radio frequency identification chip 63 may be sent to the vehicle information system 31 by way of the duplex communication system 32 through the connection 62. Such an embodiment may be extended to use in school buses, to facilitate an accounting of children which is based on information collected from radio frequency identification chips 63 associated with individual children.

Referring now to FIGS. 1 and 3, in some embodiments the signaler (13 in FIG. 1 and 32 in FIG. 3) may be housed in the same unit as the controller 16. In other embodiments, more than one signaler (13 in FIG. 1 and 32 in FIG. 3) may be housed in the same unit as the controller 16. By way of example, FIG. 7 is a sectional view of a buckle housing 11 for an adaptive light seatbelt, including a switch 13 and a controller 16 housed in a system control unit 71, according to one embodiment. In another illustrated embodiment, FIG. 8 is a sectional view of a buckle housing 11 for an adaptive light seatbelt, including a simplex communication system 32 and a controller 16 housed in a system control unit 81. In yet another illustrated embodiment, FIG. 9 is a sectional view of a buckle housing 11 for an adaptive light seatbelt, including a simplex communication system 32, a switch 13, and a controller 16 housed in a system control unit 91.

FIG. 10 is a sectional view of an adaptive light seatbelt, including a switch 13, a duplex communication system 32, a release mechanism 41, a second light 101, a radio frequency chip reader 61, and a tongue 21, according to one embodiment. The illustrated embodiment includes two signalers in the form of the duplex communication system 32 and the switch 13, as well as two light sources in lights 12 and 101. The duplex communication system 32 is capable of all of the functions of a simplex communication system. Accordingly, in the illustrated embodiment, the duplex communication system 32 may control the release mechanism 41, as previously disclosed in the discussion of FIG. 4. Additionally, the controller 16 may control the lights 12 and 101 based on the input provided by the duplex communication system 32 as discussed in the disclosure of FIG. 3. The controller 16 may also control the lights 12 and 101 based on a state of the switch 13 as previously disclosed in the discussion of FIG. 2. Lastly, the radio frequency chip reader 61 may read a radio frequency chip 63 and communicate the unique identification as discussed previously in the disclosure of FIG. 6.

By way of example, in an embodiment related to FIG. 10, the light 12 may illuminate red when a vehicle ignition is active but the tongue 21 is not inserted into the buckle housing 11, wherein the activation of the vehicle ignition is communicated to the duplex communication system 32 by the vehicle information system 31. In such an embodiment, the second light 101 illuminates green once the tongue 21 is inserted into the buckle housing 11. In a further embodiment, the light 12 may flash the color red if the tongue 21 is removed from the buckle housing 11 while the vehicle is moving, wherein the movement of the vehicle is communicated to the duplex communication system 32 by the vehicle information system 31.

Importantly, these embodiments may be used to provide a simple training paradigm for children. A child may learn to buckle her seatbelt based on the paradigm of the light 12 illuminating red when the tongue 21 is not inserted into the buckle housing 11 and the second light 101 illuminating green when the tongue 21 is inserted properly into the buckle housing 11. This paradigm may be further extended to school bus seatbelt systems. The clear visual indication provided by the lights 12 and 101 that the tongue 21 is or is not inserted into the buckle housing 11 for each seatbelt on a school bus provides a simple way to identify which children are not secured properly. Further, children around a child whose buckle is illuminating red, indicating that the tongue 21 is not inserted into the buckle housing 11, may notify the driver of the bus or tell the child to buckle their seatbelt. In a further embodiment, the light 12 may flash a distinct color if the tongue 21 is removed from the buckle housing 11 by the child while the bus is moving, to provide a more direct visual indicator that a child is not securely fastened, wherein the movement of the bus is communicated to the duplex communication system 32 by the vehicle information system 31.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention.

What is claimed is:

1. An adaptive light seatbelt system for a vehicle, comprising:
a buckle housing;
a light positioned in the buckle housing so that the light is visible to an occupant of a vehicle;
a controller for controlling light, wherein the controller is located in the buckle housing; and
a signaler for providing an input to the controller, wherein the signaler is located in the buckle housing.

2. The adaptive light seatbelt system of claim 1, wherein the buckle housing includes a light diffuser located between an outer edge of the buckle housing and the light.

3. The adaptive light seatbelt system of claim 1, wherein the light comprises an LED.

4. The adaptive light seatbelt system of claim 1, wherein the controller controls at least one of a duty cycle, a brightness, and a color of the light.

5. The adaptive light seatbelt system of claim 4, wherein the controller controls the duty cycle and the brightness of the light to create flashing.

6. The adaptive light seatbelt system of claim 1, wherein the signaler is a switch.

7. The adaptive light seatbelt system of claim 6, further comprising a tongue, configured to insert into the buckle housing; wherein the switch is configured to change states when the tongue is inserted into the buckle housing.

8. The adaptive light seatbelt system of claim 7, wherein the controller controls the color of the light based on a state of the switch.

9. The adaptive light seatbelt system of claim 1, wherein the signaler is a communication system, further configured to communicate with a vehicle information system.

10. The adaptive light seatbelt system of claim 9, further comprising a release mechanism located in the buckle housing for releasing the tongue based on a communication received from the vehicle information system.

11. The adaptive light seatbelt system of claim 9, further comprising a status sensor located in the buckle housing, and wherein the communication system is configured to send status communications to the vehicle information system indicating a status of the adaptive light seatbelt system.

12. The adaptive light seatbelt system of claim 9, further comprising:
a radio frequency identification chip reader located in the buckle housing, and connected to the communication system, for reading a radio frequency identification chip and sending communications to the vehicle information system identifying the radio frequency identification chip.

13. The adaptive light seatbelt system of claim 9, wherein the communication system is a simplex communication system.

14. The adaptive light seatbelt system of claim 9, wherein the communication system is a duplex communication system.

15. A method of adaptively lighting a seatbelt buckle having a buckle housing, a light positioned in the buckle housing, a controller located in the buckle housing and connected to the light, and a signaler located in the buckle housing and connected to the controller, comprising the steps of:
receiving an input from the signaler at the controller; and
controlling the light with the controller according to the input received from the signaler.

16. The method of claim 15, wherein the step of controlling the light comprises controlling a duty cycle and a brightness of the light to create flashing.

17. The method of claim 15, wherein the signaler comprises a switch, the seatbelt buckle further comprises a tongue, configured to insert into the buckle housing, the method, further comprising the step of:
determining whether the tongue is inserted into the buckle housing by considering a state of the switch.

18. The method of claim 17, wherein the step of controlling the light comprises controlling a color of the light based on the state of the switch.

19. The method of claim 15, wherein the signaler is a communication system and the method further comprises the step of:
receiving a communication from a vehicle information system at the signaler and providing the input to the controller according to the communication received from the vehicle information system.

20. The method of claim 19, further comprising the step of:
sending a communication to the vehicle information system from the signaler.

21. An adaptive light seatbelt system, comprising:
a buckle housing;
a tongue, configured to insert into the buckle housing;
a release mechanism, located in the buckle housing, for releasing the tongue;
a light positioned in the buckle housing so that the light is visible to an occupant of a vehicle;
a light diffuser located between an outer edge of the buckle housing and the light;
a controller, located in the buckle housing for controlling the light; and
a signaler for providing an input to the controller, wherein the signaler is located in the buckle housing.

22. A method of adaptively lighting a seatbelt buckle, comprising the steps of:
determining whether a tongue is inserted into a buckle housing;
receiving an input; and
controlling a light according to the input.
